(19) United States
(12) Patent Application Publication
(10) Pub. No.: US 2004/0045105 A1
(43) Pub. Date: Mar. 11, 2004

(54) Powered toothbrush with a hinged section

(76) Inventors: Eyal Eliav, New York, NY (US); Anthony C. Ogg, Brooklyn, NY (US); John J. Gatzemeyer, Hillsborough, NJ (US)

Correspondence Address: COLGATE-PALMOLIVE COMPANY, 909 RIVER ROAD, PISCATAWAY, NJ, 08855, US

(21) Appl. No.: 10/063,590

(22) Filed: May 3, 2002

(51) Int. Cl. A61C 17/22

(52) U.S. Cl. 15/22.1; 15/22.2; 15/28

(57) ABSTRACT

18A powered toothbrush includes a head contains a first powered bristle bearing section and a second non-powered, moving, bristle bearing section hingedly connected to and spaced apart from the balance said head, which combination of sections provides enhanced cleaning, while helping to reduce the potential harm of brushing to the soft gum tissues of the mouth.

### BACKGROUND OF INVENTION

1. Field of the Invention

The present invention relates to powered toothbrushes and more specifically to such toothbrushes having an extended, ergonomic two section bristle field, wherein the first such section provides a conventional rotating or oscillating motion in a first plane parallel to the dentiture and the second such section includes fixed bristles which when used yield in a plane generally perpendicular to said first plane and to the dentiture to reduce gum wear.

2. Discussion of Related Art

It is well known that toothbrushes provide three major benefits of oral hygiene. First, toothbrushes remove plaque and food debris to help avoid tooth decay and disease. Second, they remove stained pellicle from the surface of each tooth to help whiten the teeth. Third, the bristles combined with the brushing motion will massage the gingival tissue for stimulation and increased health thereof.

Some dentists have proclaimed the advantages of powered toothbrushes over their conventional counterparts in achieving the above oral hygiene benefits. Powered toothbrushes have been available for several years. Most of these powered toothbrushes rotate or oscillate in some manner so as to vigorously clean the teeth. These toothbrushes are conventionally powered by single use or rechargeable batteries that supply power to an electric motor that in turn drives the toothbrush head via a shaft, for example.

U.S. Pat. No. 6,000,083 discloses a low cost, ergonomically correct powered toothbrush with an extended bristle surface to support a greater quantity of toothpaste than conventional circular faced electric brushes. This extended bristle field is mounted on a head and is formed of two sections, a first conventional moving circular bristle bearing section which is driven in an oscillating or rotating manner, and a second fixed bristle section containing a field of bristles which are fixed into the head so as to be static with respect thereto. The bristles located on the first moving circular bristle bearing section are disclosed to include stiff bristles to aid in deep cleaning and in the plaque removal process and the bristles on the second fixed bristle section are said to typically consist of a softer bristle, so as not to damage the gums. However, use of such softer bristles alone on the fixed bristle section does not ameliorate the potential for harmful gum wear due to excessive force/pressure by the user during brushing.

Published PCT application WO 02/05725 discloses a powered brush head containing two sections, a first swiveling or rotating cylindrical bristle carrier section in combination with a second moving section, a moving bristle bearing web. Which bristle bearing web is free of the brush housing on three sides and is normally aligned and guided by the side walls of the housing or carrier tube. When the brush is activated and the cylindrical bristle carrier begins to swivel or rotate, the bristle bearing web will be motivated to move radially away from and toward the longitudinal axis of the brush by a resonance effect. Such a movement radially away from the longitudinal axis of the brush and toward the gums can only add to the being exerted by the user, such that the likelihood of damage being done to the soft gum tissue is increased.

Thus there is a need in the art for a toothbrush having an enlarged, two section, ergonomically correct bristle field which will also support a greater quantity of toothpaste, said bristle field being formed of a first conventional rotating or oscillating section and a second section which yields in use away from the teeth and gums, to reduce the force/pressure being applied by the user to reduce the potential harm to the soft tissues of the mouth.

### SUMMARY OF INVENTION

It is an object of the present invention to provide a powered toothbrush with a first oscillating or rotating, bristle bearing, circular, powered moving section and a second bristle bearing section which yields when the brush is in use; wherein, the sections together support a greater quantity of toothpaste than a conventional powered brush with a sole circular moving section and which sections together provide enhanced ergonomic cleaning and/or polishing teeth, while ameliorating a portion of the force/pressure applied by the user to the soft gum tissues of the mouth.

In accordance with one aspect of the present invention, an elongated powered toothbrush includes a handle at one end and a head at the other. The head having a face on one side thereof, which face contains a first oscillating or rotating section drivingly connected to a drive assembly and having a first set of bristles extending therefrom. The head also contains a second section which is hingedly connected to and spaced apart from the balance of said head portion, which second section has a second set of bristles extending therefrom and which second section remains static when said first section oscillates or rotates and no other external forces are applied thereto. The second section moves in a second plane that is substantially transverse to the face away from the dentiture during brushing, so as to yield or reduce the force/pressure being applied to the dentiture by the user to avoid harm to the soft tissues of the mouth.

### BRIEF DESCRIPTION OF DRAWINGS

The above and still further objects, features and advantages of the present invention will become apparent from the following detailed description in conjunction with the accompanying drawings; wherein, like reference numerals are intended to designate like elements, and wherein:

FIG. 1 is a side view of the first embodiment of the present invention;

FIG. 2 is a front view of the first embodiment of the present invention, as shown in FIG. 1;

FIG. 3 is a prospective view of the second embodiment of the present invention;

FIGS. 4A-4C are various cross-sectional views of alternative embodiments of the second bristle bearing section of the present invention including a hinge in accordance with one aspect of the invention; and

FIGS. 5A-5E are perspective views generally illustrating elastomeric contact elements of the present invention.

### DETAILED DESCRIPTION

One embodiment of the present invention is illustrated in FIGS. 1 and 2. A toothbrush 10 includes a neck section 12 of a handle and a head 14. The head 14 and neck 12, may be permanently attached to the handle or as is known in the art, may be replaceable, i.e. a refill head in an alternative embodiment of the present invention.

As illustrated in the figures, the head 14 includes a face composed of two sections 70 and 72, the first section 70 containing a first set of bristles 18 on a block 16 at the outermost or distal section of the head 14. In the practice of the present invention, the relative locations of said two sections 70 and 72 may be transposed, such that the second section 72 is outermost or distal section of the head 14. Further, as illustrated, a second section 72 contains a second set of bristles 32 mounted on a second block 24.

As used herein, the term bristles generally defines tooth care elements and includes any type of structure that is commonly used or is suitable for use in providing oral health benefits (e.g., tooth cleaning, tooth polishing, tooth whitening, etc.) by making intimate contact with surfaces of the teeth and surrounding areas (e.g., gingival tissue). Such bristles include but are not limited to individual bristle filaments/strands, tufts of such filaments/strands that can be formed to have a number of different shapes and sizes, and/or the bristles can also be in the form of elastomeric members, i.e. elastomeric fingers or elongated elastomeric walls which may be linear or serpentine, or the bristles can include a combination of any of the aforementioned tooth care elements.

The block 16 is preferably a disk of generally circular cross-section that rotates or oscillates in a rotational manner when power is supplied to the toothbrush 10. If desired, however, other shapes may be used for block 16, such as an egg shape or an oval or for example various regular or irregular shapes.

In the practice of the present invention, both the first and second sets of bristles 18, 32 are mounted to the blocks 16 and 24, respectively, by extending through suitable openings in the blocks so that the base of the bristles are mounted within or below the block using known stapled or in-mold tufting technology. It is also to be understood that the specific illustration of the bristles in the blocks 16, 24 are merely for exemplary purposes. The invention can be practiced with various combinations of the same or different bristle configurations and/or with the same or different bristle materials (such as nylon bristles, spiral bristles, rubber bristles, elastomeric fingers or walls, etc.). Generally, materials suitable for filament type bristles include polyamides such as nylon or polyesters such as polybutylene terephthalate. Similarly, while FIGS. 1 and 2 illustrate the bristles to be generally perpendicular to an outer surface of the head 14, some or all of the bristles may be angled at various angles with respect to the outer surface of the head 14. The combination of bristle configurations, bristle materials and bristle orientations may be selected in such a way as to achieve specific intended results, such as enhanced cleaning, massaging, tooth polishing and/or tooth whitening. Further, as disclosed in U.S. Pat. No. 6,000,083, the bristles located on said first section 70 may be relatively stiff to provide a deep cleaning and plaque removal, while the bristles located on said second section 72 may be relative soft to help in further reducing the potential for harm to the soft tissue of the mouth.

Said first bristle bearing section 70 of the present invention is power driven, being mounted for rotation or rotational oscillation by connection to a drive assembly which includes a motor located in said brush handle. Said drive assembly includes, in addition to said motor, a drive shaft which extends from said handle to said head, to impart said rotation or rotational oscillation to the first bristle bearing section, i.e. block 16. The drive assembly includes a drive shaft which connects to and motivates said first bristle bearing section by any of a plurality of known means, including any of a plurality of known geared type of drive structures to oscillate said block 16, such as disclosed in U.S. Pat. No. 6,000,083 or disclosed in PCT publication WO 01/19281. In a preferred embodiment of the present invention a drive structure incorporates the type of drive structure illustrated and described in U.S. Pat. No. 5,625,916, all of the details of which are incorporated herein by reference thereto. As described in that patent the drive shaft is rotated by a motor drive. The drive shaft terminates in an offset crank end which is located in a slot or opening in the block 16 so that the 360° rotational movement of the drive shaft is transmitted into an oscillating back and rotational movement of the block 16, as indicated by the arrow 25 in FIG. 2.

As noted above, FIGS. 1 and 2 illustrate, said second section 72 is non-powered, containing a second block 24 mounted on the head 14 and having bristle tufts 32 extending therefrom. The illustrated block 24 is generally rectangular with an irregularly shaped periphery. It is understood, however, that the block 24 can be of any irregular or regular suitable shape. As described in detail hereinbelow, the block 24 is a non-static, movable section which is hingedly connected, i.e. connected by and supported by a hinge 22, in a manner so as to be spaced apart from the remainder or balance of said head 14, which hinge is located at the innermost or proximate portion of the head 14. It will be appreciated that the block 24 is not operatively connected to the drive shaft and is not dependent on the oscillating movement of the block 16. The block 24 is spaced apart from the balance of said head 14 to allow it to be moved substantially in the direction of the arrow 26 as an external force is applied thereto, i.e. pressure against it as by use in brushing, so that the hinge 22 provides the means for the movement of the block 24. When released, the block 24 returns to its original position by swivel of the hinge 22. However, it is understood that block 24 will not move unless an external force is applied to it as in brushing, at which time it will yield away from the dentiture (as stated above, in the direction of arrow 26 in FIG. 1).

The hinge 22 is preferably injection molded of polypropylene as an integral component of the block 24, of a sufficient thickness and sturdy enough so as to prevent any significant movement of the block 24 due to vibration created by the drive motor, or any spurious resonance occurring as the result of an oscillating movement of the block 16. Alternatively, the hinge 22 may be made of a composite material including an elastomeric material and a more rigid plastic, such as polypropylene. Such a composite hinge or exclusively elastomeric hinge will enhance the dampening and absorption of any vibration from the drive motor or spurious resonance due to the oscillating motion of the block 16, to avoid any motion of block 24 toward the dentiture which may add to the undesired force/pressure on the user's soft gum tissue.

FIG. 3 shows another embodiment of the present invention which differs from the first embodiment described above, in that the block 24 includes “bristles” which are elastomeric tooth contact elements in the shape of curved walls for cleaning, massaging, etc. All other elements in the toothbrush are substantially similar to the first embodiment. That is, as in the first embodiment, a toothbrush 10 includes a neck section 12 of a handle and a head 14. The head 14 is permanently attached to the neck 12, but as stated above, may also be a refill head in an alternative embodiment of the present invention.

Still in other embodiments of the present invention, alternative designs of the block 24 are shown in sectional views in FIGS. 4A-4C, wherein the hinged connection of the block 24 is altered as is the configuration of the second bristle bearing section 72. In FIG. 4A, a block section corresponding to block 24 is conceptually comprised of 2 portions, forming a two portion block 40, 42 containing in cross-section a T-shape portion 40 and C-shape portion 42. The top surface or face 44 of the T-shape portion 40 has tooth contact elements embedded therein and extending therefrom, as described above with respect to other embodiments of the present invention. The two legs of the C-shape portion 42 are attached about the surface of the head 14 (not shown in these figures).

When the alternative embodiment shown in FIG. 4A, is placed in use, the force, i.e. the pressure applied against the teeth by the second bristle bearing section 72 will be transmitted through the upper block 40 to the descending leg of the “T” which is resiliently flexible, forcing it to move in a direction of arrows 46. This resilient flexibility of the descending leg of the “T” is provided by this leg being manufactured of a flexible plastic or elastomer, or of a generally non-flexible material which has been thinned to a width as to provide flexibility thereto without loosing the ability to provide support for the bristles mounted thereon. When released, the upper block 40 returns to its original position as shown in FIG. 4A.

Similarly, FIG. 4B shows in cross-section another option corresponding to the block 24. In this embodiment of the present invention, the corresponding block to 24 is comprised of 3 block postions which in cross-section are: a V-shape portion 48, a C-shape portion 50, and an elongated hinged bearing 52. Two ends 54 of the V-shape portion 48 have a plate (not shown) attached thereto for supporting bristles embedded therein. The two legs of the C-shape portion 50 are attached about the surface of the head 14 (not shown in this figure).

When the alternative embodiment shown in FIG. 4B is placed in use, during the brushing motion against the teeth, pressure is applied against portion 48 to force it to move in a direction of arrows 56 about the hinge 52. This motion, similar to the motion of portion 40 in FIG. 4A, is substantially perpendicular to the major, longitudinal axis of the handle and neck of the toothbrush 10. When released, the portion 48 returns to its original position as shown in FIG. 4B.

Similar to FIG. 4A is still another option as shown in FIG. 4C. In this embodiment of the present invention, a two portion block 58, 60 is comprised of 2 portions which in cross-section are: a V-shape portion 58 and a C-shape portion 60, with a hinge interface therebetween. The two ends 62 of the V-shape portion 58 have a plate (not shown) attached thereto for supporting bristles embedded therein. The two legs of the C-shape portion 60 are attached about the head 14 (not shown in this figure).

In use during the brushing motion of the teeth, the alternative embodiment shown in FIG. 4C, will have pressure applied against portion 58 to force it to move in a direction of arrows 64. This motion, similar to the motion in FIGS. 4A and 4B, is substantially perpendicular to the major, longitudinal axis of the handle and neck of the toothbrush 10. When released, portion 58 returns to its original position as shown in FIG. 4C.

In the illustrated embodiments 4A and 4C, the block portions 40 and 58 and connections to C-shaped portions 42 and 60 can be injection molded of polypropylene of a sufficient thickness and sturdy enough so as to prevent any movement due to vibration or any spurious resonance occurring as the result of an oscillating movement of the block 16. Alternatively, the block portions 40 and 58 and connections to C-shaped portions 42 and 60 may be made of a composite material including elastomeric material and polypropylene. The composite block portions 40 and 58 and connections to C-shaped portions 42 and 60, or the exclusively elastomeric block portions 40 and 58 and connections to C-shaped portions 42 and 60, all function as dampeners to absorb any vibration or spurious resonance due to the oscillating motion of the block 16. The plate disposed on the top surface 44 or 62 may be made of polypropylene, composite material of polypropylene and elastomer, or exclusively elastomer. The plate may also function as a dampener for absorbing any vibrations or spurious resonance.

It is understood, of course, that while the illustrated hinges in FIGS. 4A and 4C are shown as being comprised of 2 portions and FIG. 4B is comprised of 3 portions, other variations thereof are contemplated. Namely, these hinges may be comprised of 2, 3 or 4 longitudinally separate parts joined together, corresponding in FIG. 4A to portions 40 and 42.

Referring now to FIGS. 5A-5E, illustrating some elastomeric bristles or tooth contact elements of the present invention. FIG. 5A is a thin spike, FIG. 5B is a barrel spike, FIG. 5C is a squeegee point, FIG. 5D is an angled point and FIG. 5E is a section of an elastomeric wall. The wall of FIG. 5E can traverse two points via a straight-line course, a zigzag course, or a serpentine course. There can also be a plurality of short wall sections disposed in a group. These short wall sections can be straight lines or curved sections. All of the above elastomeric contact elements can have a smooth texture or a rough surface. In addition, the wall sections can be vertically straight, taper toward the free end or expand toward the free end. The tops of the wall can also be straight or have a curved or rectilinear cup or cut or, in opposite, have a curved or rectilinear protrusion or hump.

In the illustrated embodiments, the block 16 is oscillated back and forth in a rotational direction. The invention can, however, be practiced with other forms of oscillation such as by lateral movement in a direction transverse to the longitudinal axis or to the direction of the drive shaft, or in a direction parallel to the drive shaft. Further, additional moving sections could be provided separate from or operatively connected to the block 16 so that in addition to the hinged section there would be at least one further movable section with bristles.

In the illustrated embodiments, some of the bristle tufts 32 on the block 24 are shown to extend outwardly greater distance than the bristle tufts 18 on the block 16 so that the bristle tufts 32 terminate in the same plane when the block 24 swivels to its outermost position. Furthermore, some of the bristle tufts 18 on the block 16 are shown to extend outwardly the same distance as the bristle tufts 32 on the block 24. The invention may be practiced where the bristles in each section, namely, the oscillating block 16 and the hinged block 24 have bristles of different heights and/or different inclinations to other bristles in those sections. In addition, while the drawings illustrate all of the bristles to be substantially perpendicular to the upper surface of the head 14, one or more bristle tufts may be at a substantially nonperpendicular angle to the upper surface on any or all of the different sections of the head 14.

According to the present invention, the toothbrush 10 may be made from any materials commonly used in the art. Thus, the handle and head of the powered toothbrush can be molded from polyolefins such as polypropylenes and polyethylenes, polyamids such as nylons, and polyesters such as polyethylene terephthalate. Other suitable materials include polymethylmethacrylate, styrene acroylonitrate and cellulose esters, for example cellulose propionate.

The elastomeric contact surfaces may be made from a polymer material, such as a block copolymer. Preferred block copolymers include styrenes (for example styrene ethylene butadiene styrene, or styrene butadiene styrene), polyolefins (for example polypropylene/ethylene propylene diamine modified systems (i.e. synthetic rubber)), polyamides (for example polyamide (2 or polyamide 6), polyesters (for example polyester ester or polyether ester), polyurethanes (for example polyesterurethane, polyetherurethane or polyesteretherurethane).

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

What is claimed is:

1. An elongated powered toothbrush with a handle on one end and a head on the other end thereof, comprising:
a face on one side of the head, the face including a first section and a second section;
the first section being mounted for motion, drivingly connected to a drive assembly and having a first set of bristles extending therefrom;
the second section being displaced from said first section and hingedly connected to and otherwise spaced apart from a remainder of said head, said second section remaining static when said first section moves and no other external forces are applied to said second section;
said second section having a second set of bristles extending therefrom;
whereby, when said second set of tooth bristles are applied to the dentiture said second section yields away therefrom.

2. The powered toothbrush as claimed in claim 1, wherein said first set of bristles is comprised of individual bristles, bristle tufts and/or elastomeric elements.

3. The powered toothbrush as claimed in claim 1, wherein said second set bristles is comprised of individual bristles, bristle tufts and/or elastomeric elements.

4. The powered toothbrush as claimed in claim 1, wherein said first section contains a block from which said first set of bristles extend.

5. The powered toothbrush as claimed in claim 4, wherein said block is a disk of generally circular cross-section.

6. The powered toothbrush as claimed in claim 1, wherein said second section is comprised of a T-shaped cross-section portion hingedly connected to a C-shaped cross-section portion connected to said head, the descending portion of said T being flexible.

7. The powered toothbrush as claimed in claim 1, wherein said second section is comprised of a V-shape cross-section portion hingedly connected to a C-shape cross-section portion connected to said head.

8. The powered toothbrush as claimed in claim 1, wherein said second section is made of polypropylene material.

9. The powered toothbrush as claimed in claim 1, wherein said second section is made of elastomeric material.

10. The powered toothbrush as claimed in claim 1, wherein said second section is made of composite material comprising polypropylene and elastomer.

11. The powered toothbrush as claimed in claim 1, wherein the second section is hingedly connected to a remainder of said head by a hinge of sufficient thickness to prevent any vibrations or spurious resonance from moving said second section when said first section oscillates or rotates.

12. The powered toothbrush as claimed in claim 1, wherein the movement of said first section is selected from the group consisting of rotation, rotational oscillation, vibration, translation, lateral, and any combination thereof.

13. The powered toothbrush as claimed in claim 1, wherein said first and second sets of bristles are of different heights.

14. The powered toothbrush as claimed in claim 1, wherein said first set of bristles has elements of different heights with respect to each other.

15. The powered toothbrush as claimed in claim 1, wherein said first and second sets of bristles are of different inclinations.

16. The powered toothbrush as claimed in claim 1, wherein said second set of bristles has elements of different inclinations with respect to each other.

17. The powered toothbrush as claimed in claim 1, wherein said first section is located more distal from the brush handle than said second section.

18. The powered toothbrush as claimed in claim 1, wherein the second set of bristles located on the second section are softer than the bristles located on the first section.
